(19) United States
(12) Patent Application Publication
(10) Pub. No.: US 2022/0048649 A1
(43) Pub. Date: Feb. 17, 2022

(54) SOLAR WING

(71) Applicant: Hyperion Motors, Inc., Orange, CA (US)

(72) Inventor: Constantine E. Kafantaris, Orange, CA (US)

(73) Assignee: Hyperion Motors, Inc., Orange, CA (US)

(21) Appl. No.: 16/993,277

(22) Filed: Aug. 14, 2020

(51) Int. Cl. B64G 1/40

(52) U.S. Cl. CPC B64G 1/407; B64D 2211/00

(57) ABSTRACT

The present invention provides a system configured to move a solar wing in three dimensions to increase downforce and solar panel efficiency. This is accomplished through a solar wing, a drive mechanism, a rail mechanism, and a support mechanism. These components work in conjunction to provide a lightweight and compact system configured to move and rotate a solar wing to maximize downforce and increase solar panel efficiency.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to a solar wing, and more particularly, to a system and method for modifying the position of a solar wing to maximize downforce and optimize solar energy absorption.

### DISCUSSION OF RELATED ART

A wing can generally be described as an elongated object with a shape that will produce an aerodynamic force when air passes by it. An airfoil can generally be described as the cross-sectional shape of a wing, where the airfoil shape creates the aerodynamic force.

Various airfoil shapes exist in the prior art depending on the type of aerodynamic force desired.

Downforce can generally be described as a downward aerodynamic force created by a wing or airfoil. While the most traditionally understood implementation of a wing or airfoil is in an airplane to create lift (upward force), the same principle can be used to provide downward force. Vehicles commonly employ wings or spoilers for this purpose, generating downward vertical force to generate more grip on the road.

A solar panel, or photo-voltaic (PV) module, can generally be described as a device configured to convert sunlight into electricity. This is accomplished through a plurality of photo-voltaic cells, which use the photovoltaic effect to excite electrons within the solar panels to create a flow of electric current. The more direct the sunlight, the more efficient the solar panels can generate energy. As such, when the solar panel receives the sunlight at a perpendicular angle, this will generate the most electricity.

While wings are common in land vehicles to generate downforce, and while electric land vehicles which utilize electrical power to drive themselves are becoming more and more common, there is a continued need for a solar wing capable of providing downforce while also generating electricity through solar energy. Furthermore, there is a continued need for a solar wing which can articulate to provide dynamic downforce while also providing a more efficient conversion of solar energy into electricity. The present invention satisfies these needs.

### SUMMARY OF THE INVENTION

The present invention will provide a system configured to move a solar wing in three dimensions to increase downforce and solar panel efficiency. This is accomplished through a solar wing, a drive mechanism, a rail mechanism, and a support mechanism. These components work in conjunction to provide a lightweight and compact system configured to move and rotate a solar wing to maximize downforce and increase solar panel efficiency.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

DESCRIPTION OF THE DRAWINGS

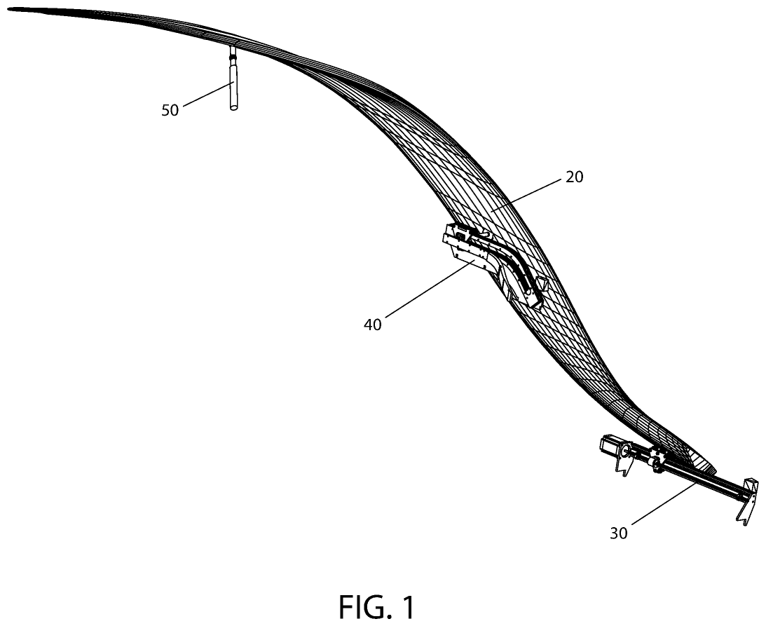

FIG. 1 is a front perspective view of the solar wing in an open position according to one embodiment of the present invention;

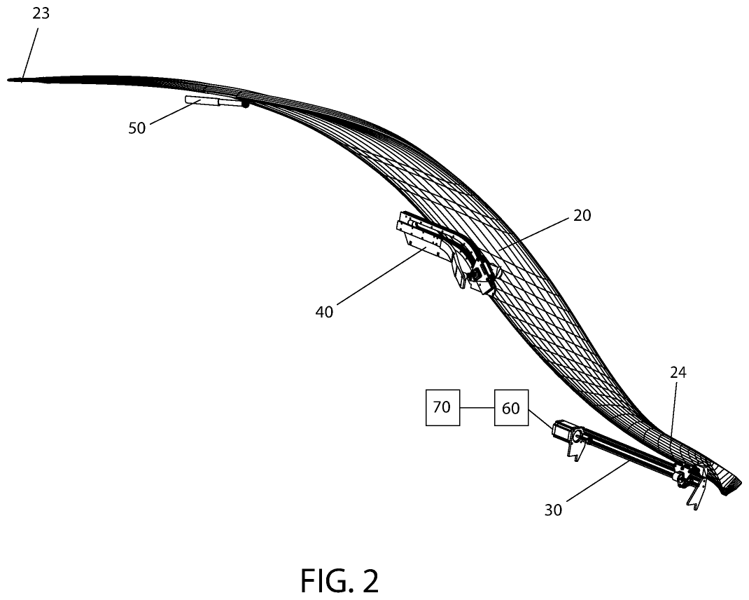

FIG. 2 is a front perspective view of the solar wing in a closed position;

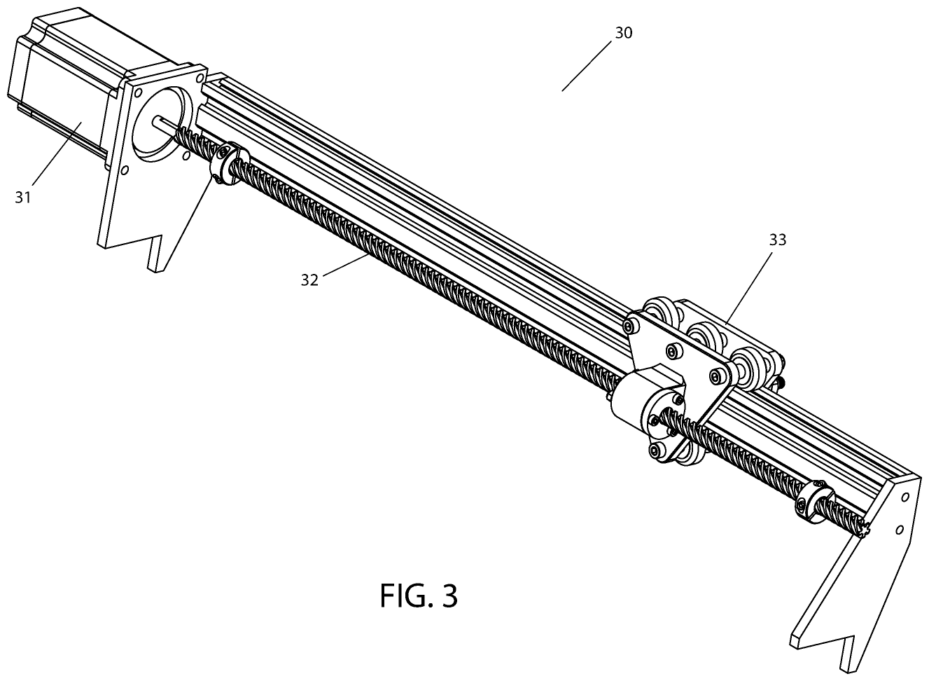

FIG. 3 is a front perspective view of the drive mechanism;

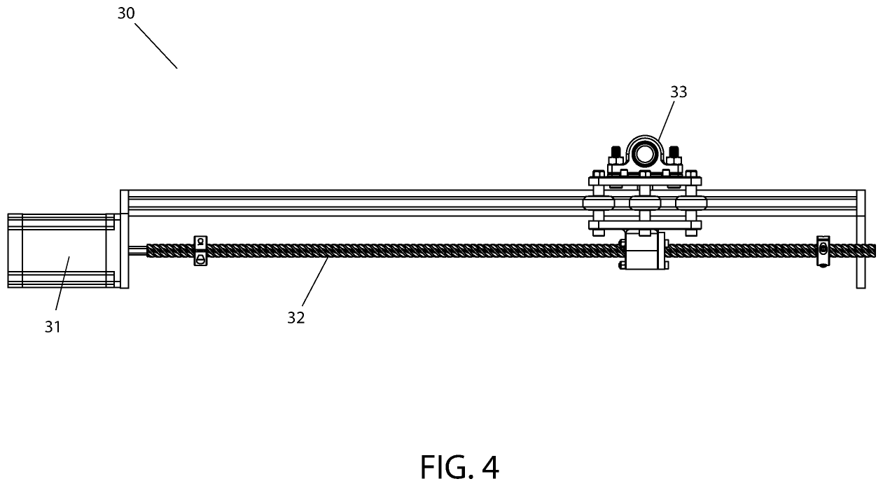

FIG. 4 is a side view therein;

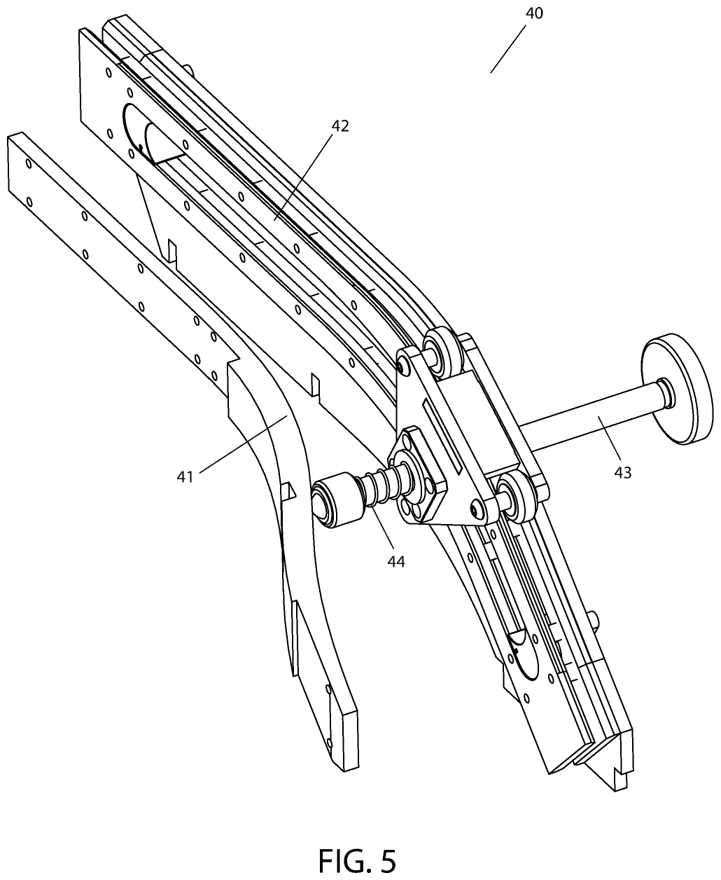

FIG. 5 is a front perspective view of the rail mechanism;

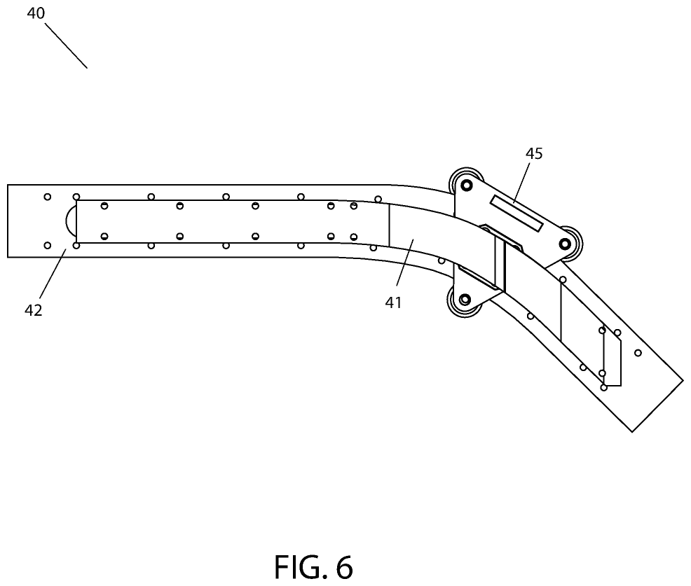

FIG. 6 is a side view therein;

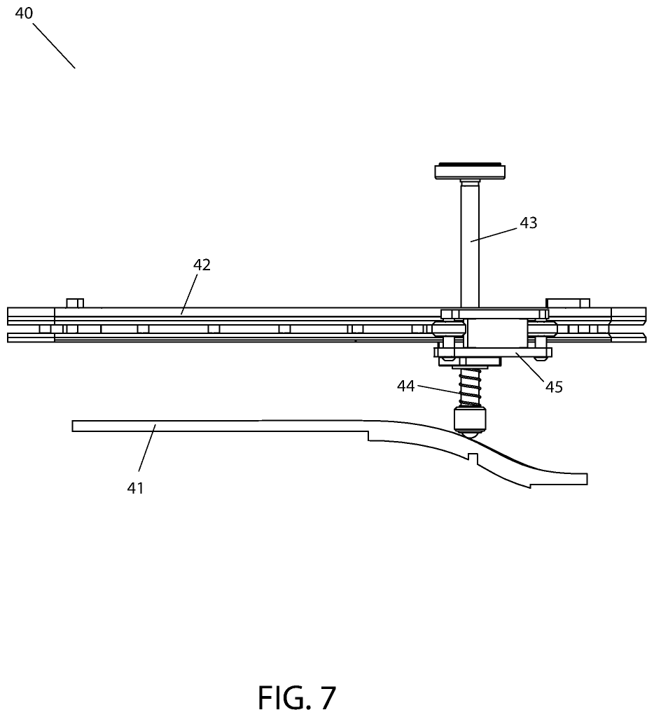

FIG. 7 is a top view therein;

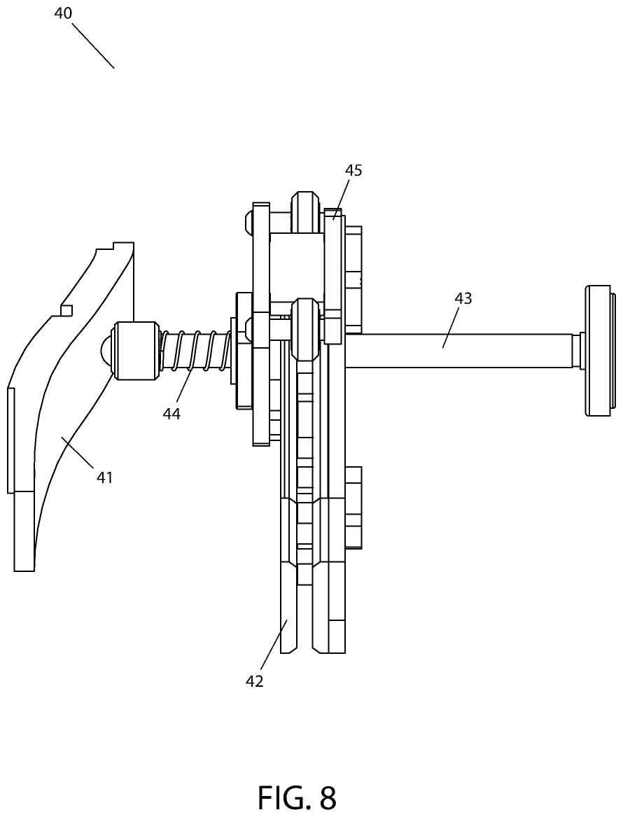

FIG. 8 is a front view therein;

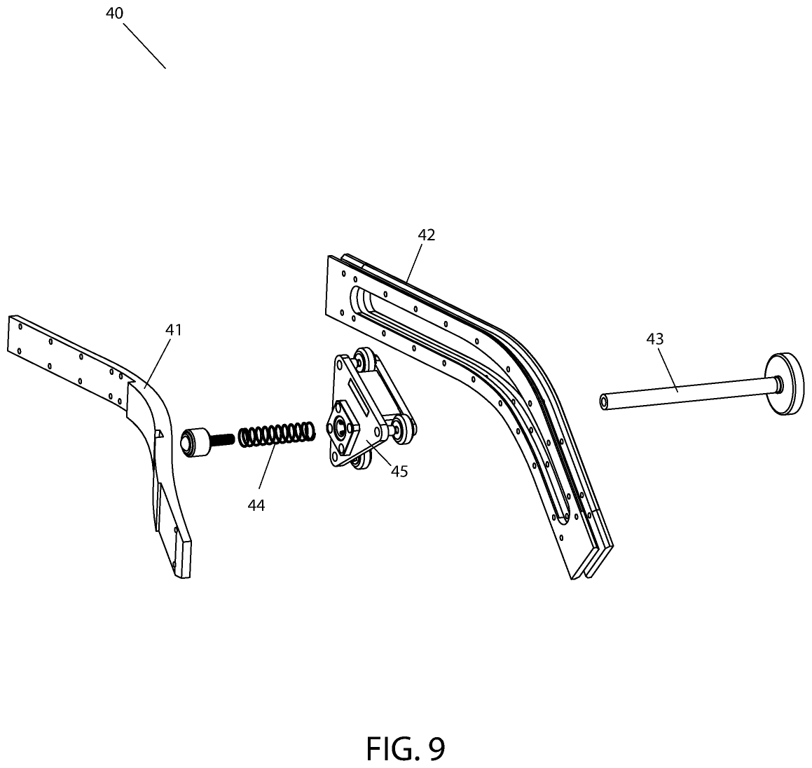

FIG. 9 is a side perspective exploded view therein;

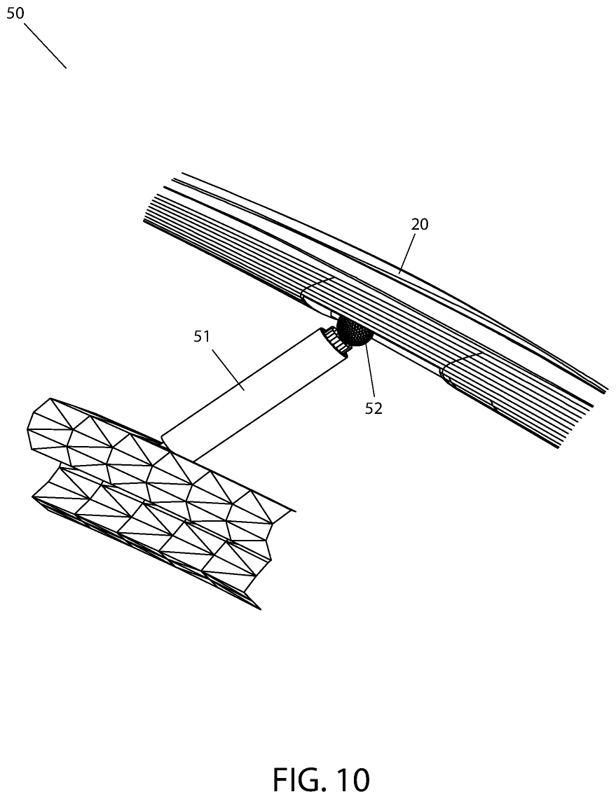

FIG. 10 is a front perspective view of the support mechanism;

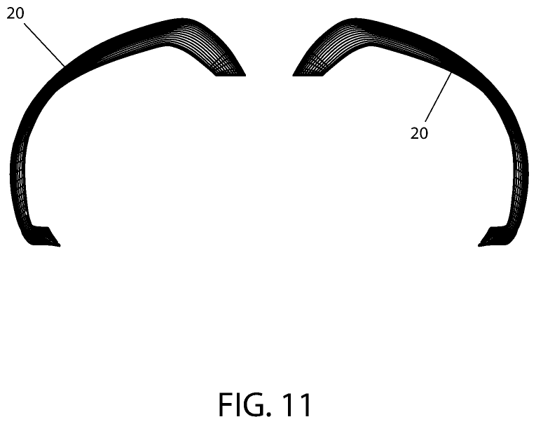

FIG. 11 is a front view of two opposing solar wings;

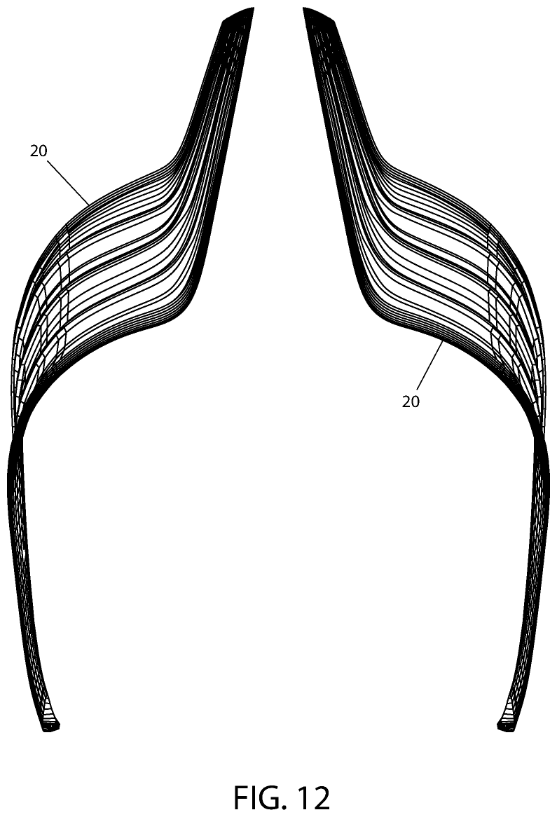

FIG. 12 is a top view therein; and

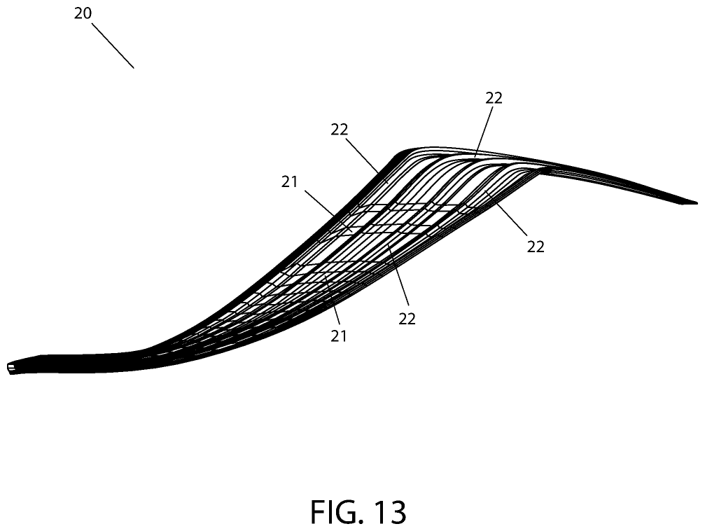

FIG. 13 is a side view therein.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The present invention comprises a solar wing 20, a drive mechanism 30, a rail mechanism 40, and a support mechanism 50. The drive mechanism 30 is positioned at the proximal end 23 of the solar wing 20 and is configured to move the solar wing 20 in a linear motion. The rail mechanism 40 is positioned between the proximal 23 and distal ends 24 of the solar wing 20 and is configured to move the solar ring 20 along a rail 42, converting the linear motion of the drive mechanism 30 into vertical and horizontal motion. The support mechanism 50 is positioned at the distal end 24 of the solar wing 20 and is configured to provide a pivot point for the solar wing 20 while it is being moved by the other mechanisms. These components work in conjunction to provide a lightweight and compact system configured to move and rotate a solar wing 20 to maximize downforce, increase solar panel efficiency, and improve cornering performance.

The solar wing 20 comprises a carbon fiber body having a proximal 23 and distal end 24. The solar wing 20 further comprises a multi junction solar inlay 21, or plurality of solar panels 21, configured to convert solar energy into electrical energy. The solar wing 20 further comprises a generally airfoil shape and has a curvature configured to convert drag forces into downward force. The solar wing 20 has three attachment points, a drive mechanism 30 at its proximal end 23, a support mechanism 50 at its distal end 24, and a rail mechanism 40 between the proximal 23 and distal ends 24. In an alternative embodiment, the solar wing 20 further comprises a plurality of ribbed support members 22 positioned between said solar panels 21 to provide structural support. In a further alternative embodiment, the solar wing 20 further comprises a clear covering for a smooth airfoil shape and for protecting the solar panels 21. In yet a further alternative embodiment, the solar wing 20 comprises an air vacuum between the clear covering and carbon fiber body to prevent damage by particulate and dust.

The drive mechanism 30 is positioned at the proximal end 23 of the solar wing 30 and is configured to move the solar wing 20 in a linear motion. The drive mechanism 30 comprises a motor 31, a drive rail 32, and a support member 33 fixedly attached to the solar wing 20. The motor 31 is configured to move the support member 33 along the drive rail 32. The drive rail 32 is configured to receive the support member 33 and to restrict its movement laterally. The support member 33 is configured to travel along the drive rail 32 and is fixedly attached to the solar wing 20.

The rail mechanism 40 comprises a cam 41, a rail 42, a shaft 43, a spring 44, and a rail support 45. The cam 41 is in a fixed position and is configured to provide outward motion to the shaft 43 as it travels along the cam 41. The rail 42 is also in a fixed position and is configured to provide upward motion to the shaft 43 as it travels within the rail 42. The shaft 43 is positioned through the rail 42 and adjacent to the cam 41, and is fixedly attached to the rail support device 45 and solar wing 20 such that any forces applied to it from the cam 41 or the rail 42 are also applied to the rail support device 45 and solar wing 220. The spring 44 is positioned about the shaft 43 between the cam 41 and the rail 42 and is configured to provide compression force between the cam 41 and rail 42 such that the shaft 43 is always positioned adjacent to the cam 41. The rail support device 45 is configured to receive the shaft 43 and guide it along the rail 42. The rail support device 45 further comprises a plurality of wheels to ensure the shaft 43 travels smoothly within the rail 42, and further comprises a means of fixedly attaching to the solar wing 20.

The cam 41 has a curved, generally convex shape and is configured to push the shaft 43 outward as the shaft 43 travels along the rail 42. More specifically, as the shaft 43 travels along the rail 42 and the surface of the cam 41, the shape of the cam 41 will force the shaft 43 to travel laterally, perpendicular to the surface of the cam 41. The spring 44 will provide the necessary outward compression force to ensure that the shaft 43 is in constant physical contact with the cam 41 during this motion and to prevent any jittering or vibration during travel.

The rail 42 has an elongated, curved shape with an aperture configured to receive the shaft 43. The rail 42 is further configured to restrict the movement of the shaft 43 between the rail 42 as it travels within said aperture and as it travels along the cam 41. As the cam 41 forces the shaft 43 to travel laterally, the rail 42 will ensure that the shaft 43 remains within a restricted area to ensure proper continuous motion. In a first position, or closed position, the drive mechanism 30 is retracted fully and the solar wing 20 is in a resting position. Here, the downforce generated by the solar wing 20 will be the lowest. In a second position, or open position, the drive mechanism 30 has driven the drive support member 33 at its furthest point on the drive rail 32, and as such, the shaft 43 will have traveled along the cam 41, causing the solar wing 30 to open vertically and laterally (outward). Here, the downforce generated by the solar wing 20 will be at its highest.

The support mechanism 50 comprises an elongated support beam 51 and a ball joint 52. The support mechanism 50 is positioned at the distal end 24 of the solar wing 20 and is configured to provide a pivot point for the solar wing 20 while it is being moved by the other mechanisms. The elongated support beam 51 is configured to provide structural support to the distal end 24 of the solar wing 20, while the ball joint 52 is configured to provide radial motion to the solar wing 20 as it moves pursuant to the lateral motion of the drive mechanism 30, the outward motion of the cam 41, and the upward motion of the rail 42.

The control mechanism 60 is configured to control the drive mechanism 30. More specifically, the control mechanism 60 is configured to produce lateral movement from the motor 31 to the support member 33 along the drive rail 32. This lateral movement will also generate upward and outward movement of the solar wing 20, depending on the desired wing position and wing angle. For example, if an increase in angle of the solar wing 20 is desired, the control mechanism 60 will activate the motor 31, causing the support member 33 to travel along the drive rail 32 until the desired solar wing 20 position and angle are produced.

In the preferred embodiment, the solar wing 20 is attached to a land vehicle and the control mechanism 60 is in electrical communication with a plurality of sensors 70. The plurality of sensors 70 further comprises velocity sensors, steering wheel angle sensors, GPS position sensors, directional sensors, pressure sensors, temperature sensors, collision sensors, fault sensors, or any other sensors which can be used to determine the properties of the vehicle and the surrounding environment. These sensors 70 may work alone or in conjunction to provide input to the control mechanism 60 to adjust the position and angle of the solar wing 20.

In this embodiment, the control mechanism 60 will process the input obtained from the vehicle's sensors 70, which includes constantly changing wing dynamics in real time, to modify the solar wing 20 position and angle relative to vehicle's axis. The control mechanism 60 is configured to optimize the output variables, wing position and wing angle, each differently depending on the driving conditions of the vehicle. Examples of output variables include increasing downforce, increasing turning force, reducing drag, or increasing solar power absorption.

In a first embodiment, when optimizing for increased turning speed, the control mechanism 60 is configured to optimize the solar wing 20 position and angle to optimize for maximum downforce. Here, the control mechanism is configured to receive vehicle velocity and steering angle from the vehicle. Using this input, the control mechanism 60 will adjust the position and angle of the solar wing 20 to maximize the downforce relative to these inputs. This will increase the grip the vehicle has on the road, increasing the speed at which the vehicle can make the turn.

In an alternative embodiment, the control mechanism 60 is configured to further optimize the solar wing 20 position and angle to optimize for downforce while in a turn by dynamically adjusting each solar wing 20 individually. Here, while the vehicle is cornering around a turn, and where the solar wings 20 are positioned on either end of the vehicle, the control mechanism 60 will receive vehicle velocity and steering angle input and adjust each solar wing 20 relative to the other such that the solar wing 20 closer to the turning corner is configured to open more than the opposing solar wing 20. This results in a force opposite to the direction of the turn, which will optimize the cornering performance while not increasing the experienced drag force.

In a further alternative embodiment, the control mechanism 60 is configured to optimize for maximum solar influx onto the multi junction solar inlay 21 in between the ribbed support members 22 along the solar wing 20. The control mechanism 60 receives velocity, time, longitude, and latitude input to ensure that the car is in a stationary position and to determine the general position of the sun relative to the position of the car. The control mechanism 60 will then modify the solar wing 20 position and angle such that the multi junction solar inlay will optimize solar absorption. More specifically, the control mechanism 60 will attempt to angle the solar inlay 21 such that it is perpendicular to the sun, as this is will produce the most energy. In an alternative embodiment, the control mechanism 60 will calculate the average angles of all solar panels and adjust the solar wing such that the highest overall energy absorption is achieved.

While the above description contains specific details regarding certain elements, sizes, and other teachings, it is understood that embodiments of the invention or any combination of them may be practiced without these specific details. For example, although certain shapes are described and shown in the above embodiments and drawings, any suitable shape may be used. These details should not be construed as limitations on the scope of any embodiment, but merely as exemplifications of the presently preferred embodiments. In other instances, well known structures, elements, and techniques have not been shown to clearly explain the details of the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A solar wing comprising:
a solar wing, said solar wing comprising a proximal end and a distal end, said solar wing further comprising a plurality of solar panels;
a driving mechanism mechanically connected to said solar wing at said proximal end, said driving mechanism configured to apply a force to said proximal end of said solar wing;
a support mechanism pivotally attached to said solar wing at said distal end;
a rail mechanism slidably attached to said solar wing between said proximal and distal ends, said rail mechanism configured to convert said force such that said solar wing may pivot about said support mechanism; and
a control mechanism configured to actuate said driving mechanism such that the position of said solar wing can be manipulated;
wherein said control mechanism is configured to adjust the position and angle of said solar wing by actuating said driving mechanism.

2. The solar wing of claim 1, wherein said rail mechanism further comprises a shaft and a rail support, wherein said shaft is fixedly attached to said rail support, and wherein said rail support is fixedly attached to said solar wing such that any movement for force applied to said shaft will also be applied to said solar wing.

3. The solar wing of claim 2, wherein said rail mechanism further comprises a rail, wherein said rail comprises an elongated, curved aperture configured to receive said shaft and force said shaft to travel within said curved aperture when said drive mechanism is actuated.

4. The solar wing of claim 3, wherein said curved aperture has an upward curve relative to said rail mechanism and wherein said upward curve will force said shaft to travel upward, generating an upward force on said solar wing when said drive mechanism is actuated.

5. The solar wing of claim 3, wherein said rail mechanism further comprises a cam, wherein said cam comprises a curved, smooth, generally convex surface, wherein said shaft is positioned adjacent to said cam, and wherein said cam is configured to apply an outward force onto said shaft as it travels along said cam.

6. The solar wing of claim 5, wherein said rail mechanism further comprises a spring positioned about said shaft between said cam and said rail and wherein said spring is configured to provide an outward compression force between said cam and said rail such that said shaft is always positioned adjacent to said cam as it travels.

7. The solar wing of claim 1, wherein said drive mechanism further comprises a motor, a drive rail, and a support member, where said motor is configured to move said support member along said drive rail, and wherein said support member is fixedly attached to said solar wing.

8. The solar wing of claim 1, wherein said support mechanism further comprises a support beam and a ball joint, wherein said support beam provides structural support to said solar wing and wherein said ball joint provides a pivot point for said solar wing.

8. The solar wing of claim 1, wherein said solar wing further comprises a plurality of solar panels.

10. The solar wing of claim 9, wherein said solar wing further comprises a plurality of ribbed support members positioned between said solar panels to provide structural support.

11. The solar wing of claim 1, wherein said solar wing further comprises a carbon fiber body.

12. The solar wing of claim 1, wherein said control mechanism further comprises a plurality of sensors, wherein said plurality of sensors are in electrical communication with said control mechanism.

13. The solar wing of claim 12, wherein said plurality of sensors include GPS sensors, velocity sensors, steering wheel angle sensors and directional sensors.

14. The solar wing of claim 13, wherein said control mechanism is configured to receive velocity and steering wheel input from said plurality of sensors, to calculate a desired downforce relative to said velocity and steering wheel input, and to actuate said drive mechanism, wherein the angle and position of said solar wing are manipulated to generate said desired downforce.

15. The solar wing of claim 13, wherein said control mechanism is configured to receive location and time input from said plurality of sensors, to calculate the position of the sun based on said location and time, to calculate a desired angle relative to said position of the sun, where said desired angle comprises a perpendicular angle, and to actuate said drive mechanism, wherein the angle and position of said solar wing are manipulated to approach said desired angle.

16. The system of claim 1, wherein said control mechanism is manually controlled.
